(19) United States
(12) Patent Application Publication
(10) Pub. No.: US 2021/0172741 A1
(43) Pub. Date: Jun. 10, 2021

(54) ACCOMPANYING SERVICE METHOD AND DEVICE FOR INTELLIGENT ROBOT

(71) Applicant: SAMSUNG ELECTRONICS CO., LTD., Suwon-si (KR)

(72) Inventors: Juan Liu, Jiangsu (CN); Rui Pan, Jiangsu (CN); Xinyan Mei, Jiangsu (CN); Kangkang Zhu, Jiangsu (CN); Xudong Jiang, Jiangsu (CN); Jie Chen, Jiangsu (CN)

(73) Assignee: SAMSUNG ELECTRONICS CO., LTD., Suwon-si (KR)

(21) Appl. No.: 17/103,141

(22) Filed: Nov. 24, 2020

(30) Foreign Application Priority Data
Dec. 4, 2019 (CN) 201911240530.2

(51) Int. Cl. G01C 21/20; G05D 1/02

(52) U.S. Cl. CPC G01C 21/20; G05D 1/0257; G05D 1/0214

(57) ABSTRACT

An accompanying service method for a robot includes obtaining a map model of a set area; planning an accompanying user path from a current position of the robot to a destination position based on the map model of the set area; monitoring an accompanied user in real time in a process of accompanying the user to travel on the planned accompanying user path; and based on the accompanied user being lost, searching for the accompanied user using a search model.

### CROSS-REFERENCE TO RELATED APPLICATION(S)

This application is based on and claims priority under 35 U.S.C. § 119 to Chinese Patent Application No. 201911240530.2, filed on Dec. 4, 2019, in the State Intellectual Property Office of China, the disclosure of which is incorporated by reference herein in its entirety.

### BACKGROUND

### 1. Field

The disclosure relates to the field of human assistance robots, and in particular to an accompanying service method for a robot, by which a user can be accompanied in a set area according to a user instruction, and can be quickly found in the event of companying failure, and an associated device.

### 2. Description of Related Art

With the development of computer technology, robots have been applied in various fields, and among them, various types of robots for assisting users have appeared in retail stores in the commercial field. For example, an infrared obstacle avoidance sensor may be set on a robot. When the sensor recognizes a user, the robot is triggered to conduct human-machine communication with the user to provide the user with the information of various commodities. Such a robot has a single motion mode, and thus cannot guide the user to a designated place.

A visual detection technology and a motion function may also be set on the robot, so that the robot can detect the user within a certain area and accompany the user to travel. However, the robot cannot continue to track the user when the user walks fast or turns sharply. Additionally, due to a complex and changing living environment having many interference factors such as crowd movement, it is easy for the robot to lose the user. Furthermore, these solutions focus on path planning and target tracking, but do not effectively consider a search problem after the user is lost.

Although the current service robots can assist users using a shopping function in retail stores in the commercial field, they cannot always accompany the users during an entire shopping process in a set area such as a retail store based on the users' instructions due to the function restrictions. In particular, during the entire shopping process of accompanying the user, when the user cannot be recognized due to an accident, the robot cannot search for and locate the user again.

### SUMMARY

Provided is an accompanying service method for a robot, by which a user can be accompanied in a set area according to a user instruction, and can be quickly found in the event of companying failure.

Provided also is an accompanying service device for a robot, by which a user can be accompanied in a set area according to a user instruction, and can be quickly found in the event of companying failure.

According to an aspect of the disclosure, an accompanying service method for a robot may include obtaining a map model of a set area; planning an accompanying user path from a current position of the robot to a destination position based on the map model of the set area; monitoring an accompanied user in real time in a process of accompanying the user to travel on the planned accompanying user path; and based on the accompanied user being lost, searching for the accompanied user using a search model.

The searching for the accompanied user by using the search model may include dividing the map model into four quadrants based on a plane rectangular coordinate system; traveling straight along a current path until an obstacle is met; detecting a movement direction of the robot within a set period of time using a movement trend estimation method and determining a next movement direction of the robot; determining a next quadrant to which the robot is to move according to the next movement direction of the robot, and searching the next quadrant by setting it as a current quadrant; and repeating the traveling straight along the current path, the detecting the movement direction of the robot within a set period of time, the determining the next movement direction of the robot, the determining a next quadrant to which the robot is to move; and the searching the next quadrant until the accompanied user is found.

The method may further include, before determining the next movement direction of the robot, setting an inner point and an outer point in each quadrant; and estimating that the movement direction of the robot within the set period of time is inward movement or outward movement. The determining the next quadrant to which the robot is to move according to the next movement direction of the robot may include based on a movement trend of the robot being outward movement and the movement direction of the robot on a plane is horizontal movement, determining a next target quadrant as a next quadrant of the current quadrant in a horizontal direction; based on a movement trend of the robot being outward movement and the movement direction of the robot on the plane is vertical movement, determining the next target quadrant as the next quadrant of the current quadrant in a vertical direction; and based on the movement trend of the robot being a move within the current quadrant, determining the next target quadrant as the current quadrant.

The searching the next quadrant by setting it as the current quadrant may include searching the current quadrant in the order of the outer point and then the inner point, or in the order of the inner point and then the outer point.

A search path for searching for the accompanied user by using the search model does may not comprise a return path. Search priorities may be set for the quadrants, and a search priority of a quadrant where a doorway in the map model is located may be set to the lowest, so that the robot searches the quadrant where the doorway is located last according to the search priority.

The process of accompanying the user to travel on the planned accompanying user path may include monitoring an obstacle on the planned accompanying user path in real time; based on detecting the obstacle, determining whether the obstacle affects accompanying the user to travel; based on the obstacle affecting accompanying the user to travel, going around the obstacle; and based on the obstacle not affecting accompanying the user to travel, continuing to travel.

The accompanying the user to travel on the planned accompanying user path may include based on the accompanied user instructing the robot to guide the user, guiding the user to travel; and based on the accompanied user instructing the robot to follow the user, following the user to travel.

Based on the accompanying the user to travel being guiding the user to travel, the monitoring the accompanied user in real time may include based on the robot determining that tracking for the accompanied user is normal and setting a safe monitoring distance, monitoring the accompanied user in real time and confirming whether the accompanied user is following the robot; based on detecting that the accompanied user is within a set following distance, continuing to travel; based on detecting that the accompanied user is outside the set safe monitoring distance, switching to a search mode, relocating the accompanied user and continuing to guide the accompanied user to travel; based on detecting that the accompanied user is outside the set following distance, but within the set safe monitoring distance, switching to a tracking mode and tracking the accompanied user; and based on detecting that the accompanied user enters the set following distance, switching to a forward state and continuing to travel. Based on the accompanying the user to travel being following the user to travel, the monitoring the accompanied user in real time may include initializing a position and speed state information of the accompanied user; estimating the position and travel speed of the accompanied user; creating a feature template of the accompanied user and performing pedestrian detection on a collected image; travelling according to a travel state of the accompanied user; detecting a distance to an obstacle ahead by using a radar module, and controlling the robot within the set following distance; and adjusting travel speed of the robot according to the estimated travel speed of the accompanied user.

The method may further include, before searching for the accompanied user by using the search model, searching for the accompanied user on the planned companying user path and relocating the accompanied user; based on the relocating being successful, terminating the process; and based on the relocating being unsuccessful, performing the step of searching for the accompanied user by using the search model.

The searching for the accompanied user and relocating the accompanied user may include based on determining that the accompanying the user to travel is guiding the user to travel, performing a reverse search based on the planned accompanying user path; based on determining that the accompanying the user to travel is following the user to travel, performing a forward search based on the planned accompanying user path; during the reverse or forward search process, obtaining images, obtaining feature information of each pedestrian in the images, and calculating feature similarity between the feature information of each pedestrian and the feature template of the accompanied user; and based on a maximum feature similarity being greater than a set similarity threshold, determining that a pedestrian having the maximum feature similarity is the accompanied user.

According to another aspect of the disclosure, an accompanying service device for a robot, may include a setting module, a path planning module, an accompanying monitoring module and a user searching module. The setting module may be configured to obtain a map model of a set area; the path planning module may be configured to plan an accompanying user path from a current position of the robot to a destination position based on the map model of the set area; the accompanying monitoring module may be configured to monitor an accompanied user in real time in a process of accompanying the user to travel on the planned accompanying user path; and the user searching module may be configured to, based on the accompanied user being lost, search for the accompanied user using a search model.

The user searching module may include a quadrant dividing and inner/outer search point setting sub-module, a search path piloting sub-module, and a target recognizing sub-module. The quadrant dividing and inner/outer search point setting sub-module may be configured to divide the map model into four quadrants based on a plane rectangular coordinate system. The search path piloting sub-module may be configured to detect that the robot travels straight along a current path until it meets an obstacle, detect a movement direction of the robot within a set period of time by using a movement trend estimation method, and determine a next movement direction of the robot. The target recognizing sub-module may be configured to determine a next quadrant to which the robot is to move according to the next movement direction of the robot, and search the next quadrant by setting it as a current quadrant. Traveling straight along the current path, the detecting the movement direction of the robot within a set period of time, the determining the next movement direction of the robot, the determining a next quadrant to which the robot is to move; and the searching the next quadrant may be repeated until the accompanied user is found.

The quadrant dividing and inner/outer search point setting sub-module may be further configured to set an inner point and an outer point in each quadrant. The search path piloting sub-module may be further configured to estimate that the movement direction of the robot within the set period of time is inward movement or outward movement based on the inner point and the outer point set in each quadrant.

The determining a next quadrant to which the robot is to move according to the next movement direction of the robot may include, based on a movement trend of the robot being outward movement and the movement direction of the robot on a plane is a horizontal movement, determining a next target quadrant as a next quadrant of the current quadrant in a horizontal direction; based on a movement trend of the robot being outward movement and the movement direction of the robot on the plane is a vertical movement, determining the next target quadrant as the next quadrant of the current quadrant in a vertical direction; and based on the movement trend of the robot being a move within the current quadrant, determining the next target quadrant as the current quadrant.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart of an accompanying service method for a robot according to an embodiment;

FIG. 2 is a structure diagram of an accompanying service device for a robot according to an embodiment;

FIG. 3 is a diagram of a process of setting a map model of a set area by a robot according to an embodiment;

FIG. 4 is a diagram of a process of voice interaction between a robot and a to-be-accompanied user according to an embodiment;

FIG. 5 is a diagram of a process of planning an accompanying user path according to an embodiment;

FIG. 6 is a diagram of a process of guiding a to-be-accompanied user to a destination position according to an embodiment;

FIG. 7 is a diagram of a process of following a to-be-accompanied user to a destination position according to an embodiment;

FIG. 8 is a diagram of a process of relocating an accompanied user according to an embodiment;

FIG. 9 is a diagram of a process of a quadrant search method according to an embodiment;

FIG. 10 is a diagram of a specific example of quadrant search method according to an embodiment;

FIG. 11 is a first diagram of a process of a first example of quadrant search method according to an embodiment;

FIG. 12 is a second diagram of a process of a first example of quadrant search method according to an embodiment;

FIG. 13 is a third diagram of a process of a first example of quadrant search method according to an embodiment; and

FIG. 14 is a fourth diagram of a process of a first example of quadrant search method according to an embodiment.

### DESCRIPTION OF EMBODIMENTS

The present disclosure includes various embodiments, some of which are illustrated in the drawings and described in detail in the detailed description. However, this disclosure is not intended to limit the embodiments described herein but includes various modifications, equivalents, and/or alternatives. In the context of the description of the drawings, like reference numerals may be used for similar components.

In addition, the embodiments described below may be modified in various different forms, and the scope of the technical concept of the disclosure is not limited to the following embodiments. Rather, these embodiments are provided so that this disclosure will be thorough and complete, and will fully convey the scope of the disclosure to those skilled in the art.

The terms used in this disclosure are used merely to describe a particular embodiment, and are not intended to limit the scope of the claims. The expression of a singular includes a plurality of representations, unless the context clearly indicates otherwise.

In this document, the expressions “have,” “may have,” “including,” or “may include” may be used to denote the presence of a feature (e.g., a component, such as a numerical value, a function, an operation, a part, or the like), and does not exclude the presence of additional features.

The expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B all together.

In addition, expressions “first”, “second”, or the like, used in the disclosure may indicate various components regardless of a sequence and/or importance of the components, will be used only in order to distinguish one component from the other components, and do not limit the corresponding components.

It is to be understood that an element (e.g., a first element) is “operatively or communicatively coupled with/to” another element (e.g., a second element) is that any such element may be directly connected to the other element or may be connected via another element (e.g., a third element).

On the other hand, when an element (e.g., a first element) is “directly connected” or “directly accessed” to another element (e.g., a second element), it can be understood that there is no other element (e.g., a third element) between the other elements.

Herein, the expression “configured to” can be used interchangeably with, for example, “suitable for,” “having the capacity to,” “designed to,” “adapted to,” “made to,” or “capable of.” The expression “configured to” does not necessarily mean “specifically designed to” in a hardware sense.

Instead, under some circumstances, “a device configured to” may indicate that such a device can perform an action along with another device or part. For example, the expression “a processor configured to perform A, B, and C” may indicate an exclusive processor (e.g., an embedded processor) to perform the corresponding action, or a generic-purpose processor (e.g., a central processor (CPU) or application processor (AP)) that can perform the corresponding actions by executing one or more software programs stored in the memory device.

The terms such as “module,” “unit,” “part”, and so on are used to refer to an element that performs at least one function or operation, and such element may be implemented as hardware or software, or a combination of hardware and software. Further, except for when each of a plurality of “modules”, “units”, “parts”, and the like needs to be realized in an individual hardware, the components may be integrated in at least one module or chip and be realized in at least one processor.

According to an embodiment, in order to accompany a user in a set area according to a user instruction, a robot may set a map model of a set area. An accompanying user path from a current position of the robot to a destination position may be planned based on the map model of the set area, and an accompanied user may be monitored in real time in a process of accompanying the user to travel on the planned accompanying user path.

Further, according to an embodiment, the user can be quickly found in the event of accompanying failure. That is, the accompanied user may be searched for by using a set inverted-I search model when it is detected that the accompanied user is lost

When it is detected that the accompanied user is lost, the accompanied user is relocated on the planned accompanying user path.

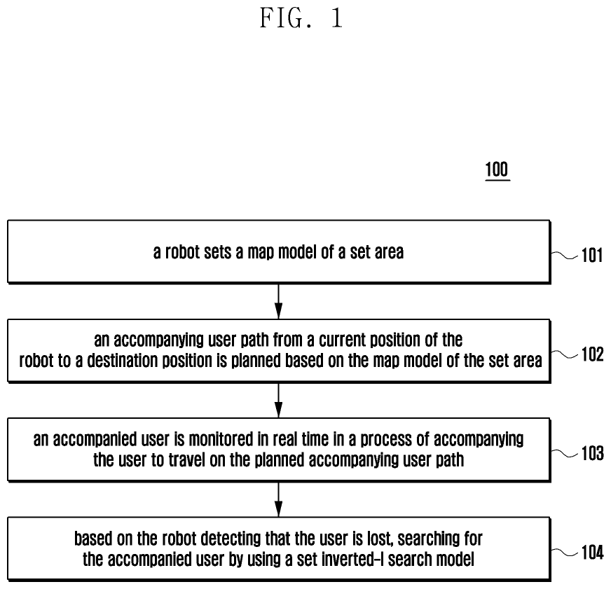

FIG. 1 is a flowchart of an accompanying service method 100 for a robot according to embodiments. The method includes following specific steps.

Step 101, a robot sets a map model of a set area.

Step 102, an accompanying user path from a current position of the robot to a destination position is planned based on the map model of the set area.

Step 103, an accompanied user is monitored in real time in a process of accompanying the user to travel on the planned accompanying user path.

Step 104, based on the robot detecting that the user is lost, searching for the accompanied user using a set inverted-I search model.

In the method 100, the searching for the accompanied user by using a set inverted-I search model may include dividing the map model into four quadrants based on a plane rectangular coordinate system, wherein the four quadrants are four regions divided by a horizontal axis and a vertical axis, and an origin of the four quadrants is a position in the map model in default. The position of the origin may be self-defined by a user, which is not limited herein.

The searching for the accompanied user by using a set inverted-I search model may further include walking straight, by the robot, along a current path until it meets an obstacle, detecting a movement direction of the robot within a set period of time by using a movement trend estimation method and determining a next movement direction of the robot; determining a next quadrant to which the robot is to move according to the next movement direction of the robot, and searching the next quadrant by taking it as a current quadrant; and repeating the above process until the accompanied user is found.

Before determining the next movement direction of the robot, the method may further include: setting an inner point and an outer point in each quadrant; and estimating that the movement direction of the robot within the set period of time is inward movement or outward movement.

The determining a next quadrant to which the robot is to move according to the next movement direction of the robot may:

when a movement trend of the robot is outward movement, if the movement direction of the robot on a plane is horizontal movement, determining a next target quadrant as a next quadrant of the current quadrant in a horizontal direction, and if the movement direction of the robot on the plane is vertical movement, determining the next target quadrant as the next quadrant of the current quadrant in a vertical direction; when the movement trend of the robot is to move within the current quadrant, determining the next target quadrant as the current quadrant.

The searching the next quadrant by taking it as the current quadrant may include searching the current quadrant according to a set principle of first outer point and then inner point, or according to a set principle of first inner point and then outer point.

According to an embodiment, a search path for searching for the accompanied user by using the set inverted-I search model does not include a return path.

According to an embodiment, search priorities are set for the quadrants, and a search priority of a quadrant where a doorway in the map model is located is set to the lowest, so that the robot finally searches the quadrant where the doorway is located according to the search priority.

In the process of accompanying the user to travel on the planned accompanying user path, the method may further include monitoring an obstacle on the planned accompanying user path in real time, and when detecting the obstacle, determining whether the obstacle affects accompanying the user to travel. Based on the obstacle affects accompanying the user to travel, the robot may go around the obstacle. Based on the obstacle affects accompanying the user to travel, the robot may continue to travel.

The accompanying the user to travel may include guiding the user to travel or following the user to travel, which are determined according to a received user instruction.

Based on the accompanying the user to travel being guiding the user to travel, the monitoring the accompanied user in real time may include when the robot determines that tracking for the accompanied user is normal, and after setting a safe monitoring distance, monitoring, by the robot, the accompanied user in real time and confirming whether the accompanied user follows it; wherein the monitoring in real time may be turn-back monitoring, or may be monitoring in real time by using a rear camera or radar set by the robot; based on detecting that the accompanied user is within a set following distance, continuing to travel; based on detecting that the accompanied user is not within the set safe monitoring distance, switching to a search mode, relocating the accompanied user and continuing to guide the accompanied user to travel; based on detecting that the accompanied user is not within the set following distance, but within the set safe monitoring distance, switching to a tracking mode and tracking the accompanied user; and based on detecting that the accompanied user enters the set following distance again, switching to a forward state and continuing to travel;

Based on the accompanying the user to travel is following the user to travel, the monitoring the accompanied user in real time may include:

initializing, by the robot, a position and speed state information of the accompanied user;

estimating, by the robot, the position and travel speed of the accompanied user;

creating, by the robot, a feature template of the accompanied user and performing pedestrian detection on a collected image;

travelling, by the robot, according to a travel state of the accompanied user;

detecting, by the robot, a distance to an obstacle ahead by using a radar module, and controlling the robot within the set following distance; and

adjusting travel speed of the robot according to the estimated travel speed of the accompanied user.

Before searching for the accompanied user by using the set inverted-I search model, the method 100 may further include:

searching for the accompanied user on the planned companying user path and relocating the accompanied user; based on the relocating is successful, terminating the process; based on the relocating is unsuccessful, performing the step of searching for the accompanied user by using the set inverted-I search model.

The searching for the accompanied user and relocating the accompanied user may include:

based on determining that the accompanying the user to travel is guiding the user to travel, performing, by the robot, reverse search based on the planned accompanying user path;

based on determining that the accompanying the user to travel is following the user to travel, performing, by the robot, forward search based on the planned accompanying user path; and

in the reverse or forward search process, collecting, by the robot, images in turn, obtaining feature information of each pedestrian in the images, and calculating feature similarity between the feature information of each pedestrian and the feature template of the accompanied user; when maximum feature similarity is greater than a set similarity threshold, determining that a pedestrian having the maximum feature similarity is the accompanied user.

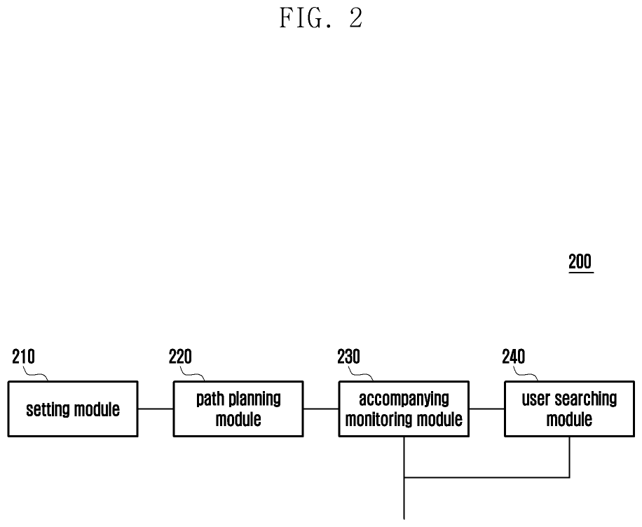

FIG. 2 is a structure diagram of an accompanying service device 200 for a robot according to an embodiment, which includes a setting module 210, a path planning module 220, an accompanying monitoring module 230, and a user searching module 240, wherein:

The setting module 210 may be configured to set a map model of a set area.

The path planning module 220 may be configured to plan an accompanying user path from a current position of the robot to a destination position based on the map model of the set area.

The accompanying monitoring module 230 is may be configured to monitor an accompanied user in real time in a process of accompanying the user to travel on the planned accompanying user path.

The user searching module 240 may be configured to search for the accompanied user by using a set inverted-I search model when detecting that the accompanied user is lost.

The user searching module may include a quadrant dividing and inner/outer search point setting sub-module, a search path piloting sub-module and a target recognizing sub-module.

The quadrant dividing and inner/outer search point setting sub-module may be configured to divide the map model into four quadrants based on a plane rectangular coordinate system The four quadrants are four regions divided by a horizontal axis and a vertical axis, and an origin of the four quadrants is a position in the map model in default. The position of the origin may be self-defined by users, which is not limited herein.

The search path piloting sub-module may be configured to detect that the robot travels straight along a current path until it meets an obstacle, detect a movement direction of the robot within a set period of time by using a movement trend estimation method and determine a next movement direction of the robot.

The target recognizing sub-module may be configured to determine a next quadrant to which the robot is to move according to the next movement direction of the robot, and search the next quadrant by taking it as a current quadrant; repeat the above process until the accompanied user is found.

The quadrant dividing and inner/outer search point setting sub-module may be further configured to set an inner point and an outer point in each quadrant.

The search path piloting sub-module may be further configured to estimate that the movement direction of the robot within the set period of time is inward movement or outward movement based on the inner point and the outer point set in each quadrant.

The determining a next quadrant to which the robot is to move according to the next movement direction of the robot may include:

based on a movement trend of the robot being outward movement and the movement direction of the robot on a plane is horizontal movement, determining a next target quadrant as a next quadrant of the current quadrant in a horizontal direction, and based on the movement direction of the robot on the plane is vertical movement, determining the next target quadrant as the next quadrant of the current quadrant in a vertical direction. Based on the movement trend of the robot being movement within the current quadrant, determining the next target quadrant as the current quadrant.

The device 200 may further include a relocating module, configured to, before searching for the accompanied user by using the set inverted-I search model, search for the accompanied user on the planned companying user path and relocating the accompanied user.

The monitoring module may be further configured to monitor an obstacle on the planned accompanying user path in real time, and when detecting the obstacle, determine whether the obstacle affects accompanying the user to travel. Based on the obstacle affecting accompanying the user to travel, the robot may go around the obstacle. Based on the obstacle not affecting accompanying the user to travel, the robot may continue to travel.

In order to provide the above method and device, a plurality of algorithms may be used, which may include an object size estimation algorithm, a user monitoring and tracking algorithm, a full-graph search and user locating algorithm, a path planning and automatic correction algorithm.

According to an embodiment, a method may generally include the following operations.

1) For a set area such as a retail store, the robot loads two-dimensional (2D) and three-dimensional (3D) map models of the retail store, for example, obtains them by a simultaneous localization and mapping (SLAM) mode.

2) The robot determines a user to be accompanied and a destination position of the user according to a set voice interaction function.

3) An accompanying user path from a current position of the robot to the destination position is planned according to the path planning and automatic correction algorithm.

4) The accompanied user is guided to the destination position according to the planned accompanying user path.

5) When determining that the accompanying the user is following the user in operation 2), the robot follows the user; when determining that the accompanying the user is guiding the user in operation 2), the robot guides the user.

6) In the process of following or guiding the user, the robot estimates the size of an obstacle on the planned accompanying user path by using the object size estimation algorithm.

7) It is determined according to the estimated size of the obstacle whether to continue the following or guiding process or to choose going around the obstacle.

8) The user is monitored by using the user monitoring and tracking algorithm.

9) When the user cannot be detected, the user is relocated and searched for on the planned accompanying user path by using the full-graph search and user locating algorithm.

The above nine operations will be described in detail below.

1) For the set area, the robot may set the 2D and 3D map models of the set area. In this example, the set area is a retail store.

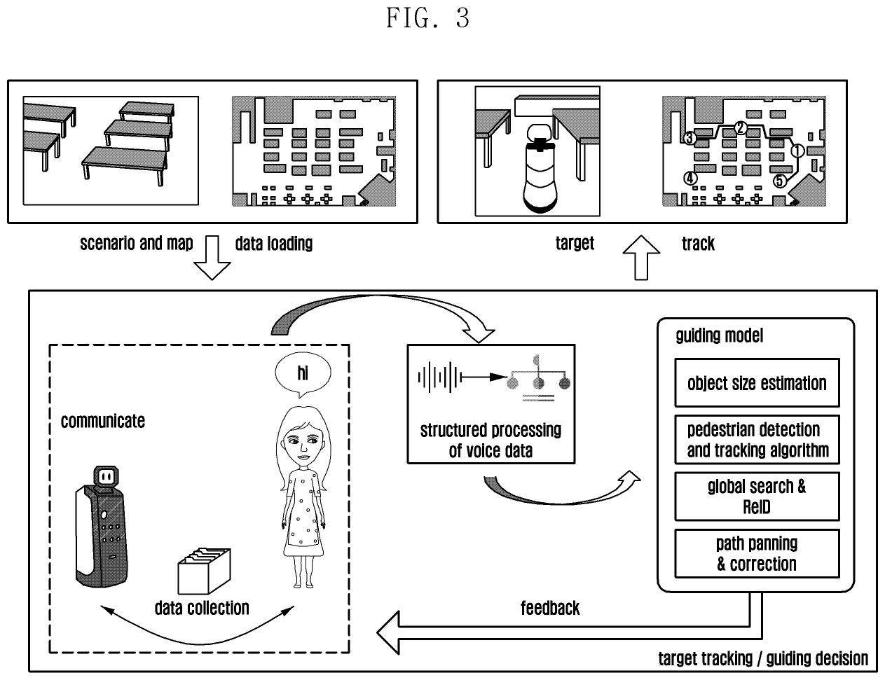

FIG. 3 is a diagram of a process of setting a map model of a set area by a robot according to an embodiment. The process may include the following operations:

The robot may initialize a current service range by loading scenario and map data; import a 2D map or a 3D map; determine the position of the robot in the current scenario during the initialization process of the robot.

The robot may initialize sensor units, such as a camera for data collection, a radar device for sensing distance, a depth camera for collecting depth information and a language acquisition device.

The robot may also initialize a rotation drive module. After the initialization of various functions is completed, the robot may serve the user to be accompanied.

2) The robot may determine a user to be accompanied and a destination position of the user according to a set voice interaction function.

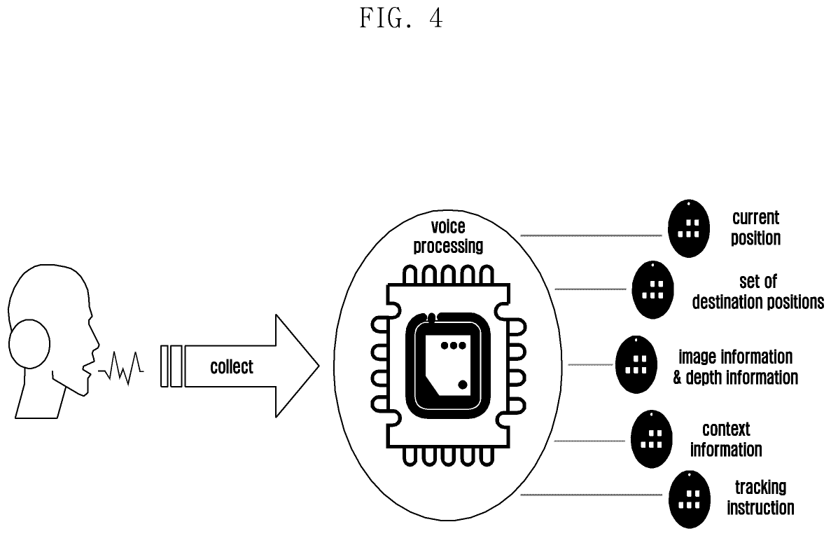

FIG. 4 is a diagram of a process of voice interaction between a robot and a to-be-accompanied user according to an embodiment. The process may include the following operations:

The robot may communicate with the accompanied user through a set voice module during the service process; analyze collected voice data; the robot constructs structured service data, such as features of tracked target, a coordinate of current position, a coordinate of destination position, an identifier of tracked target, etc.

The robot may construct an intermediate site for the destination position during the voice interaction process; for example, if the collected voice is ‘taking me to a mobile phone booth and a tablet booth’, determines the destination position as the mobile phone booth and the tablet booth during the destination parsing process.

The robot may parse a current tracking instruction, which may be 0, 1 or 2, where 0 is set to an original state, 1 is set to a following state, and 2 is set to a guiding state.

Based on the current tracking instruction being determined as the following state, the robot may start a tracking program to follow the accompanied user.

Based on the current tracking instruction being determined as the guiding state, the robot may start a guiding program to guide the accompanied user to the destination position.

3) An accompanying user path from a current position of the robot to the destination position is planned according to the path planning and automatic correction algorithm.

Herein, the robot may plan a travel path based on the current position and a set of destination positions of the robot after the robot obtains the structured information of the accompanied user.

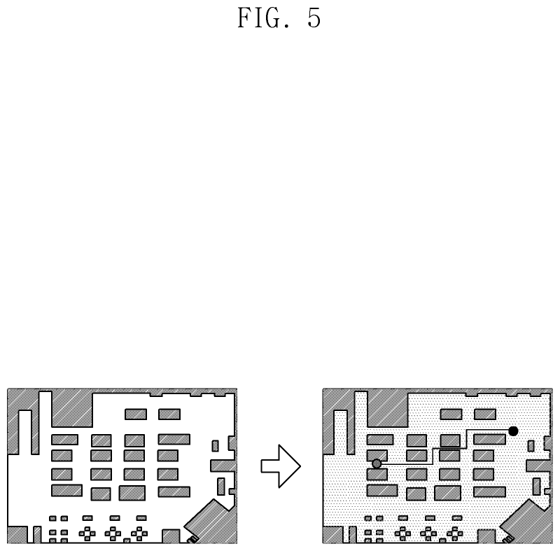

FIG. 5 is a diagram of a process of planning an accompanying user path according to an embodiment. The process may include the following operations:

Perform rasterization processing on a floor plan corresponding to the scenario by taking N as a minimum unit; determine an intersection point of abscissa and ordinate as a travel point, which deletes a space occupied by the obstacle; perform a next operation based on a tracking instruction state of the structured data; obtain a coordinate of the destination position when the current tracking instruction indicates the guiding state; construct an optimal path from the current position of the robot to the destination position by using the path planning and automatic correction algorithm; start to guide the accompanied user to the destination position subsequently.

Based on the the current tracking instruction indicating the following state, the process may extract the feature information of the accompanied user, that is, the feature information and identifier of the tracked target, and then start to track the accompanied user; and based on the current tracking instruction indicates an original state, the process may continue the voice interaction and perform information collection.

4) The accompanied user is guided to the destination position according to the planned accompanying user path.

5) Based on determining that the accompanying the user is following the user in operation 2), the robot may follow the user; based on determining that the accompanying the user is guiding the user in operation 2), the robot may guide the user.

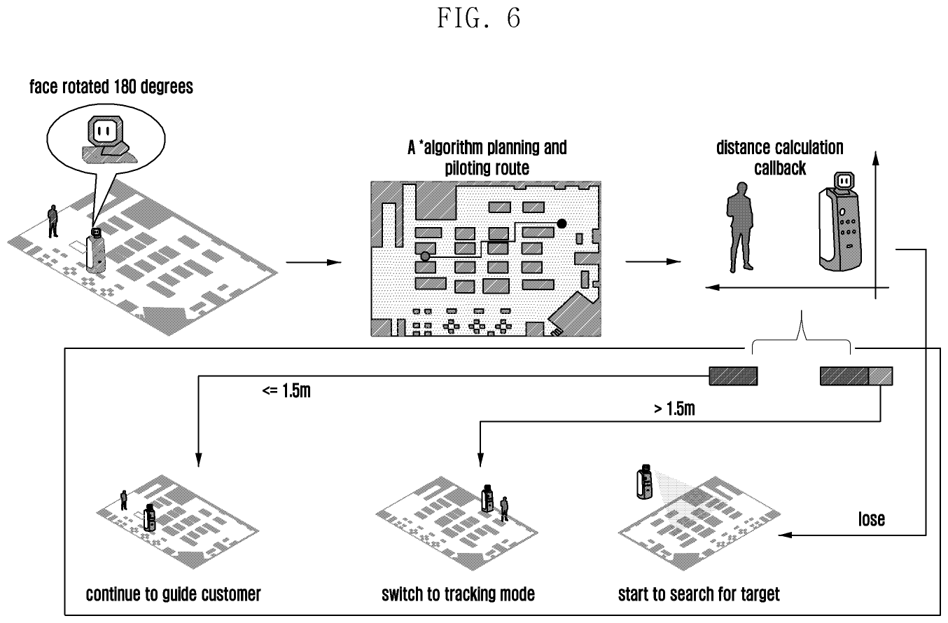

FIG. 6 is a diagram of a process of guiding a to-be-accompanied user to a destination position according to an embodiment. According to the collected tracking instruction, if the current state is the guiding state, the robot guides the accompanied user to the destination position. The process may include the following operations:

the robot may perform guiding state confirmation, destination position confirmation and accompanied user confirmation;

the robot may rotate to a designated direction according to the planned accompanying user path;

the robot may scan a current travel path;

after calculating the current position, the robot may calculate the size of a surrounding obstacle based on the data collected by the camera;

the robot may determine whether to travel according to the current surrounding environment information;

the robot may set the travel speed of the robot;

the robot may send a forward instruction, and starts to move forward;

after a set monitoring distance, the robot may turn back to monitor the accompanied user and determines whether the accompanied user follows it;

based on detecting that the accompanied user is within a set following distance, the robot may switch to the forward state and continue to travel; Based on detecting that the accompanied user is not within the set safe monitoring distance, the robot may switch to a search mode, relocate the accompanied user and continue to guide the accompanied user to travel; and

the robot may confirm the destination position of the accompanied user.

Based on detecting that the accompanied user not being within the set following distance, but within the set safe monitoring distance, the robot may switch to a tracking mode and track the accompanied user; and based on detecting that the accompanied user enters the set following distance again, the robot may switch to the forward state and continue to travel.

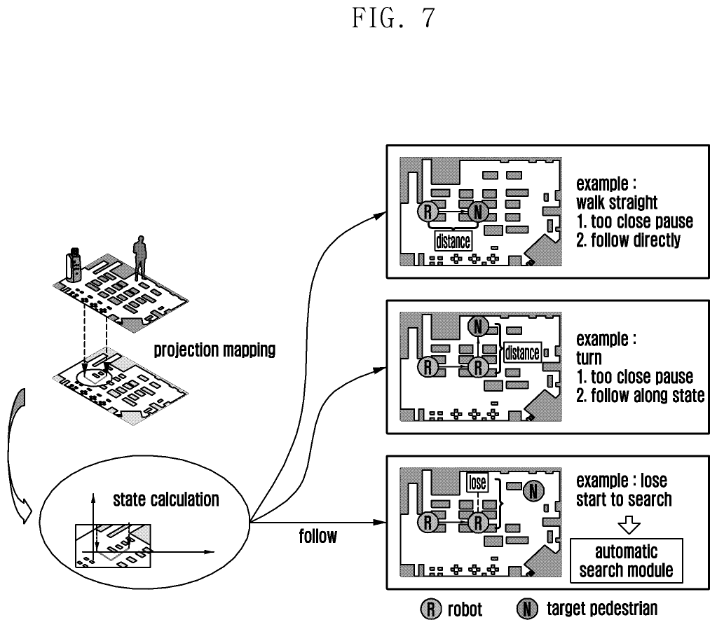

The robot may follow the accompanied user within a certain distance by using the user monitoring and tracking algorithm. When the accompanied user is lost, the accompanied user is relocated by means of retrieval. FIG. 7 is a diagram of a process of following a to-be-accompanied user to a destination position according to an embodiment. The process may include the following operations:

the robot may perform following state confirmation and accompanied user confirmation;

the robot may initialize the position and speed state information of the accompanied user;

the robot may estimate the position and travel speed of the accompanied user based on a Kalman filtering method;

the robot may perform pedestrian detection on collected image frames through a regression-based target detection network model;

the robot may create a feature template of the accompanied user by integrating the Histogram of Oriented Gradient (HOG) of the accompanied user and integrating human features extracted by a CN and Convolutional Neural Network (CNN) model;

the robot may travel according to a travel state of the accompanied user;

the robot may detect a distance to an obstacle ahead by using a radar module, and is controlled within the set following distance; and

a travel speed of the robot may be adjusted according to the estimated travel speed of the accompanied user;

if the accompanied user is lost, the robot may switch to a search and relocating mode; and

the robot may continue to travel after relocating the companied user.

9) When the user cannot be detected, the user may be relocated and searched for on the planned accompanying user path by using the full-graph search and user locating algorithm.

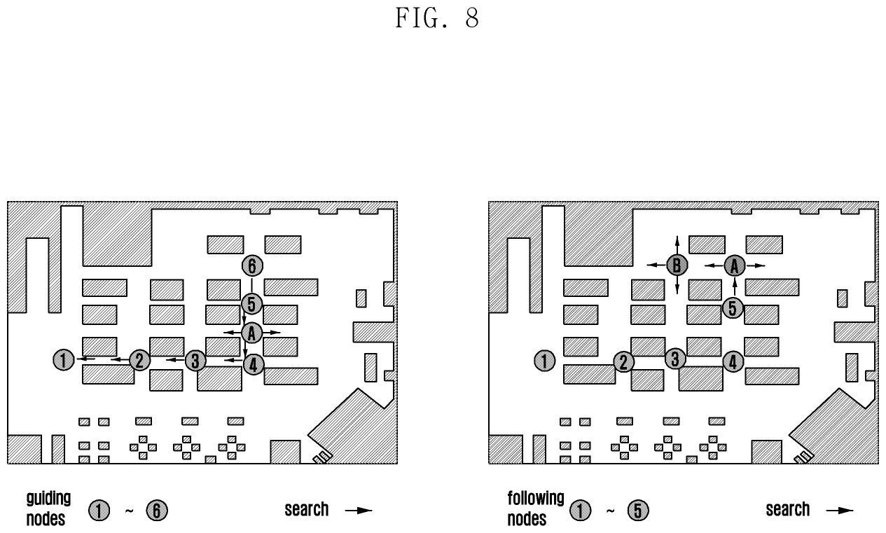

FIG. 8 is a diagram of a process of relocating an accompanied user according to an embodiment. If the accompanied user is lost when the robot guides or follows the accompanied user, a search and pedestrian recognition algorithm is used to search for the accompanied user. The search may include forward search and backward search according to different instruction modes. When the companied user is lost during the process of guiding the companied user, the companied user is searched for through a backward breadth-first search mode. When the companied user is lost during the process of following the accompanied user, a forward breadth-first search mode is performed according to the current tracking state and a predicted travel state of the accompanied user. If the accompanied user is found within a set period of time T, the robot continues to guide or follow the accompanied user; otherwise, the accompanied user is marked as a massing state and the robot terminates the current task and executes a next service.

A specific process of relocating a user may include the following:

a) the robot may perform state confirmation, extract features of the accompanied user, and initialize a target locating flag to false;

b) based on the current state of the robot being the guiding state (state: 2), the robot may perform reverse search based on the accompanying user path panned in step 3);

c) based on the current state of the robot being the following state (state: 1), the robot may perform forward search according to an estimation state set during the following process;

d) the robot may obtain image data collected by the current camera;

e) the robot may detect the size of the obstacle in the current state;

f) the robot may detect pedestrian information in the current state and extract features of pedestrian;

g) the robot may compare the features of the current pedestrian with the feature template of the accompanied user based on Gaussian correlation filtering method to obtain feature similarity;

h) the robot may obtain a maximum value of feature similarity, if it is greater than a set threshold, it is indicated that the accompanied user is found, and modify the target locating flag to true;

i) the robot may determine a travel state based on the size of the obstacle;

j) during the search process, the robot may determine intersections on the planned path, and perform information collection and retrieval by using an original position steering camera at a crossroad and a T-shaped intersection;

k) based on detecting that the target locating flag is false, the robot may search a next frame and repeats operations f)˜j);

l) based on detecting that the target locating flag is true, it is indicated that the accompanied user is found and the robot executes the process of following or guiding the accompanied user;

m) Based on the search on the planned accompanying user path ending and the accompanied user is not found within the set period of time T, the robot may terminate the current service and execute a next service.

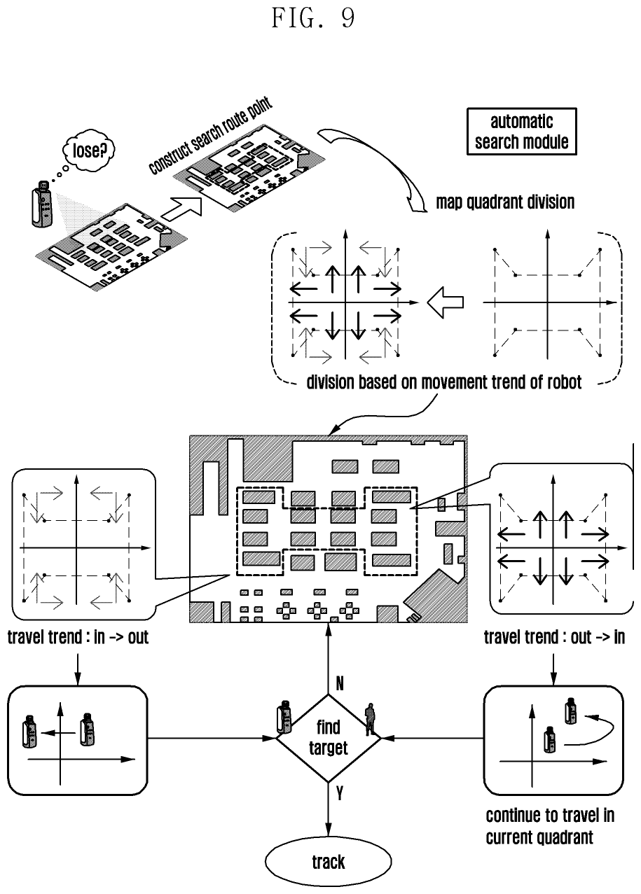

According to an embodiment, during a process of searching for and relocating the lost accompanied user, the robot may search for the accompanied user based on a target locating and identifying method and performs feature matching, which may combine with the process of the quadrant search method provided by the embodiment of the present application shown in FIG. 9. Herein, an inverted-I search model is set, the search is performed respectively for the guiding state and the following state, and the quadrant search is implemented after walking the path reserved in the respective state. The specific process may include the following operations.

a) After walking the planned accompanying user path, if the accompanied user is still not found, a search route point may be constructed.

b) The current map model may be divided into four quadrants, and an inner search route and an outer search route may be set according to a set distance.

c) A search point and a quadrant pointed by the current movement direction of the robot may be determined.

d) An intersection angle of the travel position in each quadrant may be calculated.

e) A next movement direction may be achieved according to the results of steps c) and d).

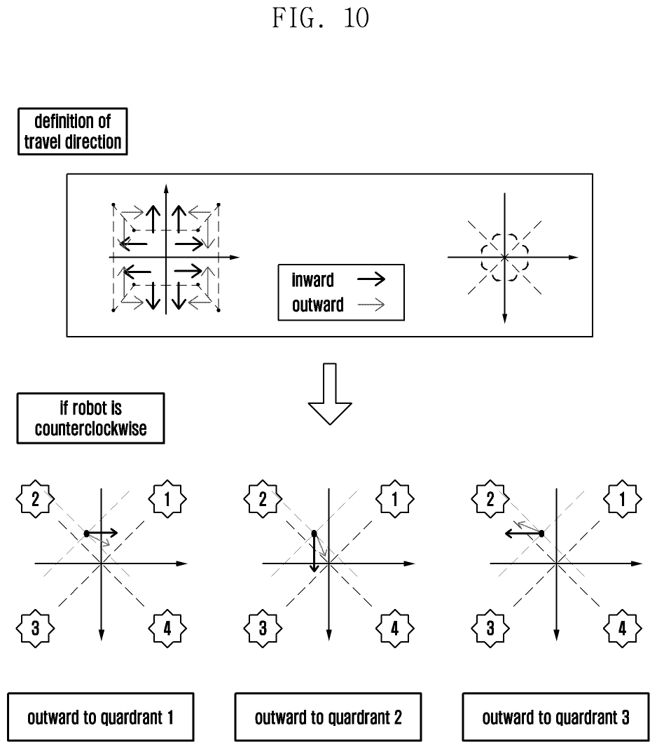

f) FIG. 10 is a diagram of a specific example of a quadrant search method according to an embodiment. As shown in FIG. 10, when the travel trend is in to out, target recognition may be performed on collected images. If no target is recognized, the robot may travel to a next quadrant pointed by the movement direction along the search route to search the next quadrant.

g) As shown in FIG. 10, when the travel trend is out to in, the target recognition may be performed on the collected images. If no target is recognized, travel in the current quadrant to search the current quadrant according to the search point in operation a).

h) Operations a) to g) are repeated. If the target is found, the instruction state before the target search may be continued.

j) If the target is still not found after the set period of time T, the service may be terminated.

k) When the robot terminates the service or the service is completed, the robot may be ready for a next service.

The foregoing describes an embodiment of a process of searching for the user by using the inverted-I search model. An example method includes the following:

divide the map model into four quadrants, and set an inner point and an outer point in each quadrant; wherein the four quadrants are four regions divided by a horizontal axis and a vertical axis, an origin of the four quadrants is a center position in the map model in default, and the position of the origin may be self-defined by a user;

the robot walks straight along a current path until it meets an obstacle;

estimate a movement trend of the robot according to the movement direction of the robot within a minimum time slice, determine the movement direction of the robot is inward movement or outward movement in the current quadrant, and determine the next movement direction of the robot;

based on the movement trend of the robot being outward movement, if the movement direction of the robot on a plane is horizontal movement, determine a next target quadrant as a next quadrant of the current quadrant in a horizontal direction, and if the movement direction of the robot on the plane is vertical movement, determine the next target quadrant as the next quadrant of the current quadrant in a vertical direction; when the movement trend of the robot is to move within the current quadrant, determine the next target quadrant as the current quadrant;

after determining the next target quadrant, determine a target search point according to a principle of first outer point and then inner point; if the outer point has been searched, select the inner point; if the outer point and inner point in the current quadrant have been searched, continue to search a next target quadrant according to the previous step;

repeat the above process until the user is found.

Three specific examples will be provided below to describe the embodiments in detail.

### First Example

In a first scenario, when a customer quickly runs away from a store due to an emergency, the robot finds that the customer is lost, and then searches for the customer by using the set inverted-I search model.

The process of the first example may include the following operations.

Operation s101: a quadrant dividing and inner/outer search point setting sub-module is configured to divide the map model into four quadrants, set an upper right quadrant as a first quadrant, and set remaining quadrants in a counterclockwise order as a second quadrant, a third quadrant and a fourth quadrant respectively, set an inner search point and an outer search point in each quadrant, wherein if a search mark of each search point is false, it is indicated that the search point has never been visited.

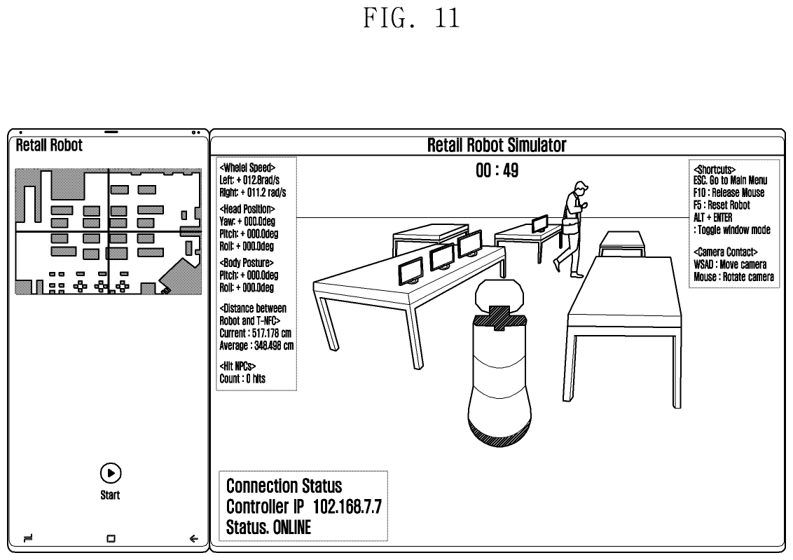

For this example, as shown in FIG. 11, assume that the robot is located in the third quadrant when the user is lost, and the movement direction of the robot is a horizontal outward direction.

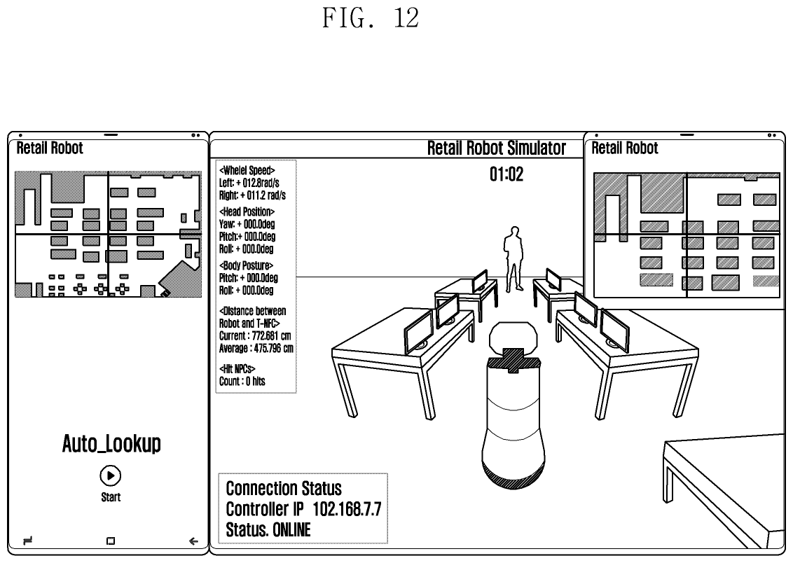

Operation s102: a search path piloting sub-module starts to work and starts to plan a next search point when the robot walks straight and meets an obstacle. As shown in FIG. 12, the robot is still in the third quadrant at this time and the movement trend of the robot is horizontal right, and the next quadrant should be the fourth quadrant. Because the quadrant where the doorway is located has the lowest priority (in general, the doorway is the last searched place) in the embodiments of the present application, a next search point is determined as an outer point of the first quadrant.

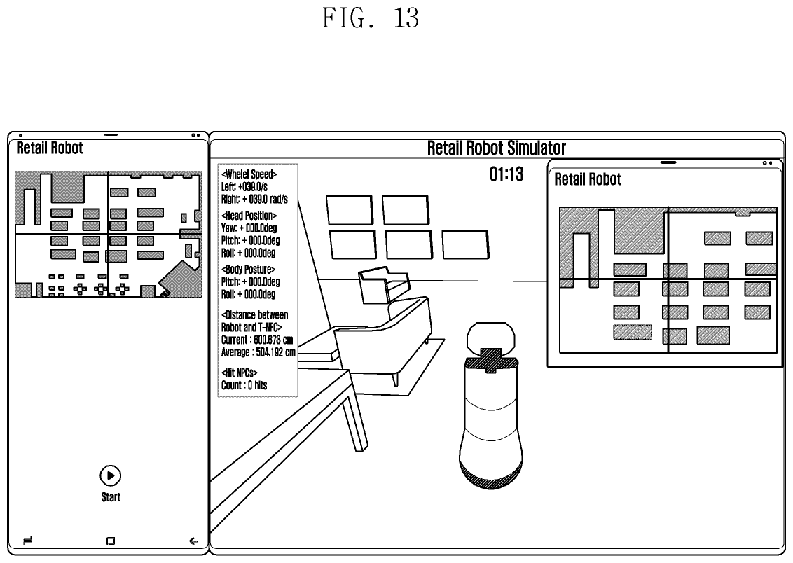

Operation s103: as shown in FIG. 13, the robot travels on a path to the outer point of the first quadrant and passes by the inner point of the first quadrant. According to a principle of not going back, the search mark of the inner point is marked as true, and the inner point does not need to be searched again.

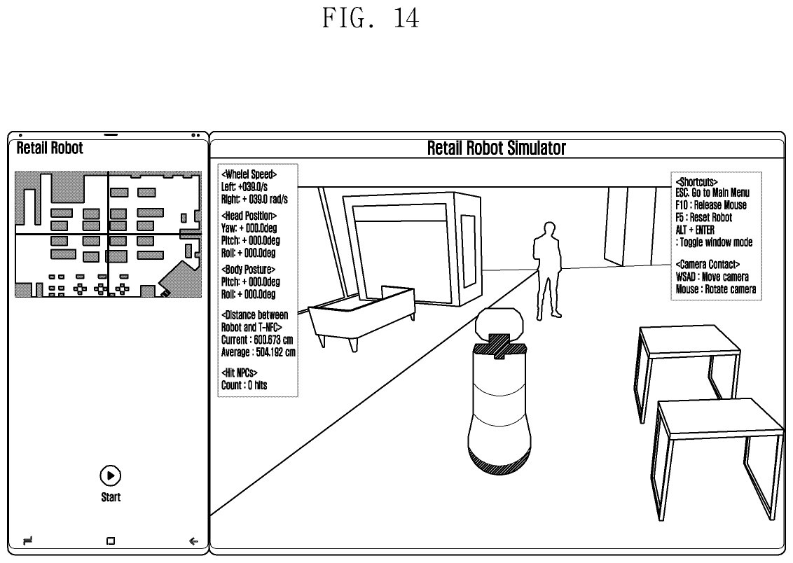

Operation s104: as shown in FIG. 14, when the robot travels to the outer point of the first quadrant, the target recognizing sub-module recognizes the target customer, the search mode is exited, and the tracking mode is started.

### Second Example

In a second scenario, when a customer purchases some heavy commodities and wants to place them on a robot tray so as to be led to a checkout counter, the customer places the commodities on the tray and communicates with the robot. After communicating with the customer, the robot gets that the customer's wish is to go to the checkout counter. The tracking instruction indicates a guiding mode, and a guiding function is enabled at this time to lead the customer to the destination.

The implementation process includes the following.

Operation S101: the robot is started to serve the customer.

Operation S102: The customer communicates with the robot by voice, tells the robot to lead him to the checkout counter and to carry some commodities for him.

Operation S103: The robot responds that the customer may place the commodities on the tray and may follow it to the checkout counter, extracts feature information of the customer and creates a feature template for the feature information.

Operation S104: After confirming that the commodities have been placed on the tray, the customer tells the robot to go to the checkout counter.

Operation S105: The robot plans a path, scans the surrounding environment, and calculates a distance to an obstacle ahead.

Operation S106: when determining that it can continue to travel on the current planned path, the robot guides the customer to travel.

Operation S107: the robot performs object size detection for a scenario of image data per frame collected by the camera to determine that the current path can be passed.

Operation S108: The robot performs turn-back detection every 20-second time interval, performs pedestrian detection and determines whether the features of currently detected pedestrian can match with those of the target customer. If the features of currently detected pedestrian can match with those of the target customer, the robot saves the features of the current customer and continues to travel; otherwise, it is indicated that the tracked target customer is in a missing state, and the robot searches for the target customer.

For this example, assume that the target customer is in the missing state after 2 minutes in operation S108, at this time the robot starts a search mode, and returns from the original path to search for the target customer through reverse path search.

Operation S109: during the search process, the robot collects the current environment information from each frame, extracts human target features in the environment through human target feature detection, performs European-style distance comparison for the detected human target features and the feature template of the target customer created in operations S103 and S108 to obtain the feature similarity between features of all pedestrians in the currently collected frame and the feature template of the target customer. If the maximum feature similarity is greater than 90%, it is indicated that the target customer is detected, the search terminates, and the robot tracks the target customer and tells the customer to follow it.

Operation S110: when a crossroad and a T-shaped intersection are encountered during the search process, the robot scans the surrounding environment in situ steering. The scanning process is similar to operation S110.

Operation S111: if the target customer is still not found when the robot reaches a starting point, a search route point is constructed based on the current environment, and the robot travels to the search points of different quadrants according to the movement trend of the robot to search for the target customer.

Operation S112: if the robot does not find the target customer within 5 minutes, the robot terminates the search.

Operation S113: after the robot finds the target customer in operation S110, the process from operation S105 to operation S112 is repeated.

Operation S114: when reaching the destination, the guiding task terminates.

Operation S115: the process ends, and the robot are ready for a next service.

### Third Example

In a third scenario, in a process of updating counter commodities, a salesperson needs to take the commodities for many times due to the large number of commodities. At this time, the salesperson communicates with the robot and hopes that the robot follows him to a warehouse to pick up some commodities and then place the new commodities on the shelves. After communicating with the robot, the robot gets that the tracking instruction indicates the tracking mode, and then starts a following function to assist the salesperson to update the commodities. The process may include the following operations.

Operation S101: the robot is started to serve the customer.

Operation S102: the salesperson communicates with the robot by voice, and tells the robot to go to the warehouse to pick up some commodities.

Operation S103: the robot gets that the tracking instruction indicates the following mode through voice analysis.

Operation S104: the feature information of the salesperson is collected through a camera, and a feature template of the followed target is created.

Operation S105: a target tracking module is started, and the movement direction and speed state information of the target are estimated based on a Kalman filtering method.

Operation S106: the travel speed of the robot in the tracking process is adjusted dynamically according to the following speed.

Operation S107: when the tracked target is lost during the tracking process, a target search is started.

Operation S108: forward search is performed based on the movement state information estimated in operation S105.

Operation S109: scenario information of the next frame is collected, pedestrians in the scenario are detected, and the feature information of the detected pedestrians is extracted.

Operation S110: the feature information of the pedestrians is compared in operations S104 and S109 to obtain the feature similarity between features of all pedestrians in the currently collected frame and those of the target customer. If the maximum feature similarity is greater than 90%, it is indicated that the target customer is detected, the search terminates, and the robot tracks the target customer and tell the customer to follow it.

Operation S111: when a crossroad and a T-shaped intersection are encountered during the search process, the robot scans the surrounding environment in situ steering. The scanning process is similar to operation S110.

Operation S112: the robot continues to travel, and searches the destination of the salesperson preferentially based on the path planning algorithm.

Operation S113: if the target customer is still not found when the robot reaches a starting point, a search route point is constructed based on the current environment, and the robot travels to the search points of different quadrants according to the movement trend of the robot to search for the target customer.

Operation S114: if the robot does not find the target customer within 5 minutes, the robot terminates the search.

Operation S115: after the robot finds the target customer in step S112, the process from step S105 to operation S113 is repeated.

Operation S116: when reaching the destination, the guiding task terminates.

Operation S117: the process ends, and the robot are ready for a next service.

In light of the above, a machine guiding and following model and method are provided. A target user search model may be set based on the movement trend of the robot, which can effectively improve the problem of losing the target customer during the service process. By using the pedestrian recognition method, the efficiency of searching for the lost target customer can be improved.

The foregoing is only discussing example embodiments and is not used to limit the protection scope of the present application. Any modification, equivalent substitution and improvement without departing from the spirit and principle of the present application are within the protection scope of the present application.

1. An accompanying service method for a robot, comprising:
obtaining a map model of a set area;
planning an accompanying user path from a current position of the robot to a destination position based on the map model of the set area;
monitoring an accompanied user in real time in a process of accompanying the user to travel on the planned accompanying user path; and
based on the accompanied user being lost, searching for the accompanied user using a search model.

2. The method of claim 1, wherein the searching for the accompanied user by using the search model comprises:
dividing the map model into four quadrants based on a plane rectangular coordinate system;
traveling straight along a current path until an obstacle is met;
detecting a movement direction of the robot within a set period of time using a movement trend estimation method and determining a next movement direction of the robot;
determining a next quadrant to which the robot is to move according to the next movement direction of the robot, and searching the next quadrant by setting it as a current quadrant; and
repeating the traveling straight along the current path, the detecting the movement direction of the robot within a set period of time, the determining the next movement direction of the robot, the determining a next quadrant to which the robot is to move; and the searching the next quadrant until the accompanied user is found.

3. The method of claim 2, further comprising, before determining the next movement direction of the robot:
setting an inner point and an outer point in each quadrant; and
estimating that the movement direction of the robot within the set period of time is inward movement or outward movement;
wherein the determining the next quadrant to which the robot is to move according to the next movement direction of the robot comprises:
based on a movement trend of the robot being outward movement and the movement direction of the robot on a plane is horizontal movement, determining a next target quadrant as a next quadrant of the current quadrant in a horizontal direction;
based on a movement trend of the robot being outward movement and the movement direction of the robot on the plane is vertical movement, determining the next target quadrant as the next quadrant of the current quadrant in a vertical direction; and
based on the movement trend of the robot being a move within the current quadrant, determining the next target quadrant as the current quadrant.

4. The method of claim 3, wherein the searching the next quadrant by setting it as the current quadrant comprises:
searching the current quadrant in the order of the outer point and then the inner point, or in the order of the inner point and then the outer point.

5. The method of claim 4, wherein a search path for searching for the accompanied user by using the search model does not comprise a return path, and
wherein search priorities are set for the quadrants, and a search priority of a quadrant where a doorway in the map model is located is set to the lowest, so that the robot searches the quadrant where the doorway is located last according to the search priority.

6. The method of claim 1, wherein the process of accompanying the user to travel on the planned accompanying user path comprises:
monitoring an obstacle on the planned accompanying user path in real time;
based on detecting the obstacle, determining whether the obstacle affects accompanying the user to travel;
based on the obstacle affecting accompanying the user to travel, going around the obstacle; and
based on the obstacle not affecting accompanying the user to travel, continuing to travel.

7. The method of claim 1, wherein the accompanying the user to travel on the planned accompanying user path comprises:
based on the accompanied user instructing the robot to guide the user, guiding the user to travel; and
based on the accompanied user instructing the robot to follow the user, following the user to travel.

8. The method of claim 7, wherein, based on the accompanying the user to travel being guiding the user to travel, the monitoring the accompanied user in real time comprises:
based on the robot determining that tracking for the accompanied user is normal and setting a safe monitoring distance, monitoring the accompanied user in real time and confirming whether the accompanied user is following the robot;
based on detecting that the accompanied user is within a set following distance, continuing to travel;
based on detecting that the accompanied user is outside the set safe monitoring distance, switching to a search mode, relocating the accompanied user and continuing to guide the accompanied user to travel;
based on detecting that the accompanied user is outside the set following distance, but within the set safe monitoring distance, switching to a tracking mode and tracking the accompanied user; and
based on detecting that the accompanied user enters the set following distance, switching to a forward state and continuing to travel; and
based on the accompanying the user to travel being following the user to travel, the monitoring the accompanied user in real time comprises:
initializing a position and speed state information of the accompanied user;
estimating the position and travel speed of the accompanied user;
creating a feature template of the accompanied user and performing pedestrian detection on a collected image;
travelling according to a travel state of the accompanied user;
detecting a distance to an obstacle ahead by using a radar module, and controlling the robot within the set following distance; and
adjusting travel speed of the robot according to the estimated travel speed of the accompanied user.

9. The method of claim 1, further comprising, before searching for the accompanied user by using the search model:
searching for the accompanied user on the planned companying user path and relocating the accompanied user;
based on the relocating being successful, terminating the process; and
based on the relocating being unsuccessful, performing the step of searching for the accompanied user by using the search model.

10. The method of claim 9, wherein the searching for the accompanied user and relocating the accompanied user comprises:
based on determining that the accompanying the user to travel is guiding the user to travel, performing a reverse search based on the planned accompanying user path;
based on determining that the accompanying the user to travel is following the user to travel, performing a forward search based on the planned accompanying user path;
during the reverse or forward search process, obtaining images, obtaining feature information of each pedestrian in the images, and calculating feature similarity between the feature information of each pedestrian and the feature template of the accompanied user; and
based on a maximum feature similarity being greater than a set similarity threshold, determining that a pedestrian having the maximum feature similarity is the accompanied user.

11. An accompanying service device for a robot, comprising a setting module, a path planning module, an accompanying monitoring module and a user searching module, wherein:
the setting module is configured to obtain a map model of a set area;
the path planning module is configured to plan an accompanying user path from a current position of the robot to a destination position based on the map model of the set area;
the accompanying monitoring module is configured to monitor an accompanied user in real time in a process of accompanying the user to travel on the planned accompanying user path; and
the user searching module is configured to, based on the accompanied user being lost, search for the accompanied user using a search model.

12. The device of claim 11, wherein the user searching module comprises a quadrant dividing and inner/outer search point setting sub-module, a search path piloting sub-module, and a target recognizing sub-module,
wherein the quadrant dividing and inner/outer search point setting sub-module is configured to divide the map model into four quadrants based on a plane rectangular coordinate system,
wherein the search path piloting sub-module is configured to detect that the robot travels straight along a current path until it meets an obstacle, detect a movement direction of the robot within a set period of time by using a movement trend estimation method, and determine a next movement direction of the robot,
wherein the target recognizing sub-module is configured to determine a next quadrant to which the robot is to move according to the next movement direction of the robot, and search the next quadrant by setting it as a current quadrant, and
wherein traveling straight along the current path, the detecting the movement direction of the robot within a set period of time, the determining the next movement direction of the robot, the determining a next quadrant to which the robot is to move, and the searching the next quadrant are repeated until the accompanied user is found.

13. The device of claim 12, wherein the quadrant dividing and inner/outer search point setting sub-module is further configured to set an inner point and an outer point in each quadrant,
wherein the search path piloting sub-module is further configured to estimate that the movement direction of the robot within the set period of time is inward movement or outward movement based on the inner point and the outer point set in each quadrant, and
wherein the determining a next quadrant to which the robot is to move according to the next movement direction of the robot comprises:
based on a movement trend of the robot being outward movement and the movement direction of the robot on a plane is a horizontal movement, determining a next target quadrant as a next quadrant of the current quadrant in a horizontal direction;
based on a movement trend of the robot being outward movement and the movement direction of the robot on the plane is a vertical movement, determining the next target quadrant as the next quadrant of the current quadrant in a vertical direction; and
based on the movement trend of the robot being a move within the current quadrant, determining the next target quadrant as the current quadrant.
